(19) United States
(12) Patent Application Publication
(10) Pub. No.: US 2023/0062773 A1
(43) Pub. Date: Mar. 2, 2023

(54) NONVOLATILE MEMORY AND MEMORY SYSTEM

(71) Applicant: KIOXIA CORPORATION, Tokyo (JP)

(72) Inventor: Akiyuki KANEKO, Yokohama Kanagawa (JP)

(21) Appl. No.: 17/686,285

(22) Filed: Mar. 3, 2022

(30) Foreign Application Priority Data
Aug. 24, 2021 (JP) 2021-136460

(51) Int. Cl. G06F 3/06

(52) U.S. Cl. CPC G06F 3/0659; G06F 3/0604; G06F 3/0679

(57) ABSTRACT

A nonvolatile memory includes a memory element, a buffer, and a control circuit that controls writing of data into the memory element or reading of data from the memory element. The control circuit reads data requested in a first command from the memory element when the first command is received, and stores the data in the buffer. In response to a second command that includes write data, the control circuit compares the write data with the data stored in the buffer, and writes only a portion of the write data that is different from the data stored in the buffer in to the memory element.

### CROSS-REFERENCE TO RELATED APPLICATION

This application is based upon and claims the benefit of priority from Japanese Patent Application No. 2021-136460, filed Aug. 24, 2021, the entire contents of which are incorporated herein by reference.

### FIELD

Embodiments described herein relate generally to a nonvolatile memory and a memory system.

### BACKGROUND

In recent years, storage class memory (SCM) has attracted attention as occupying a new position in a memory hierarchy with performance that is between main memory and storage.

It is desirable that the unit size in which the host accesses an SCM module (which is a memory system including the SCM and a controller that controls the SCM) and the unit size in which the controller accesses the SCM in the SCM module are the same. However, in reality, the access unit sizes of the two are different for various reasons in many cases.

When the access unit sizes of both are different, it creates various types of overhead. For example, whenever write data is received from the host to be written to the SCM, and the host unit size is smaller than the SCM unit size, a read process is first performed to retrieve data from the location of the SCM that will be partially overwritten. Then, the write data from the host is merged into the retrieved data and the merged data is written out to the SCM. Such overhead deteriorates the write latency and the endurance of the SCM module.

### DESCRIPTION OF THE DRAWINGS

FIG. 1 is a diagram illustrating a configuration example illustrating a memory system of a first embodiment.

FIGS. 2A and 2B are diagrams illustrating a first operation performed when a memory system of a comparative example receives a write command from a host.

FIGS. 3A and 3B are second diagrams illustrating a second operation performed when the memory system of the comparative example receives the write command from the host.

FIGS. 4A and 4B are diagrams illustrating a relationship between a size of a data main body and a correction ability when a size ratio of the data main body and parity is the same.

FIGS. 5A1, 5A2, and 5B are diagrams illustrating an example of how data may be stored in a nonvolatile memory.

FIGS. 6A and 6B are diagrams illustrating an operation when the memory system according to the first embodiment receives the write command from the host.

FIG. 7 is a sequence diagram illustrating a flow of an operation in case of reading data in an information processing system that includes the memory system according to the first embodiment.

FIG. 8 is a flowchart illustrating an operation procedure in case of reading data in the information processing system that includes the memory system according to the first embodiment.

FIGS. 9A and 9B are diagrams illustrating a configuration example of the memory system according to a second embodiment.

FIG. 10 is a sequence diagram illustrating a flow of an operation in case of reading data in an information processing system that includes the memory system according to the second embodiment.

FIG. 11 is a flowchart illustrating an operation procedure in case of reading data in the information processing system that includes the memory system according to the second embodiment.

FIGS. 12A and 12B are diagrams illustrating a configuration example of a memory system according to a third embodiment.

FIG. 13 is a sequence diagram illustrating a flow of an operation in case of reading data in an information processing system that includes the memory system according to the third embodiment.

FIG. 14 is a flowchart illustrating an operation procedure in case of reading data in the information processing system that includes the memory system according to the third embodiment.

### DETAILED DESCRIPTION

Embodiments provide a nonvolatile memory and a memory system that can reduce overhead in case of writing data.

In general, according to one embodiment, a nonvolatile memory includes a memory element, a buffer, and a control circuit. The control circuit controls writing of data into the memory element or reading of data from the memory element. The control circuit reads data requested in a first command from the memory element when the first command is received, and stores the data in the buffer. In response to a second command that includes write data, the control circuit compares the write data with the data stored in the buffer, and writes only a portion of the write data that is different from the data stored in the buffer into the memory element.

Hereinafter, embodiments of the present disclosure are described with reference to the drawings.

### First Embodiment

First, a first embodiment is described.

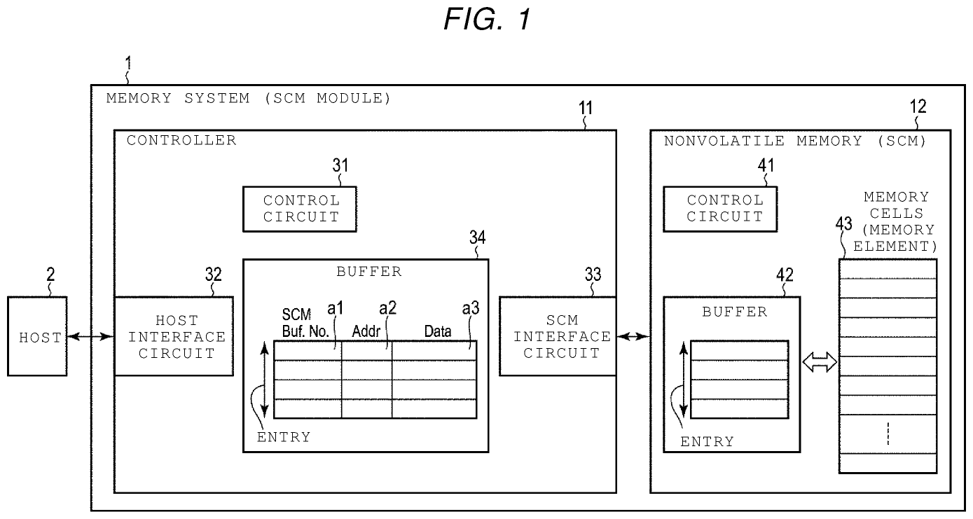

FIG. 1 is a diagram illustrating a configuration example of a memory system 1 according to the first embodiment. In FIG. 1, a configuration example of the information processing system including the memory system 1 and a host 2 connected to the memory system 1 is also illustrated. The host 2 is an information processing device such as a server or a personal computer.

As illustrated in FIG. 1, the memory system 1 includes a controller 11 and a nonvolatile memory 12.

The controller 11 is a device that controls of the writing of data to the nonvolatile memory 12 and the reading of data from the nonvolatile memory 12 according to a command from the host 2. The controller 11 is configured, for example, as a system-on-a-chip (SoC).

The nonvolatile memory 12 is, for example, an SCM. The SCM is an overwrite-type nonvolatile memory such as a phase-change memory (PCM), a magnetoresistive memory (magnetoresistive random access memory [RAM]: MRAM), a resistance change memory (Resistive RAM: ReRAM), and a ferroelectric memory (Ferroelectric RAM: FeRAM). That is, here, an example in which the memory system 1 is implemented as an SCM module is shown.

The controller 11 includes a control circuit 31, a host interface circuit 32, an SCM interface circuit 33, and a buffer 34.

The control circuit 31 is a device that controls components in the controller 11, specifically, the host interface circuit 32, the SCM interface circuit 33, and the buffer 34. The control circuit 31 receives a command from the host 2 via the host interface circuit 32. The control circuit 31 controls a writing process of data to the nonvolatile memory 12 or a reading process of data from the nonvolatile memory 12 via the SCM interface circuit 33 according to the command from the host 2. The control circuit 31 outputs a result of the writing process of the data and the reading process of the data to the host 2 via the host interface circuit 32. The control circuit 31 uses the buffer 34 for efficiently writing data requested by the host 2. A method of using the buffer 34 is described below.

The host interface circuit 32 is a device that communicates with the host 2, for example, by the compute express link (CXL) protocol or the NVDIMM-P bus protocol. The SCM interface circuit 33 is a device that controls the transmission and reception of data with the nonvolatile memory 12.

The buffer 34 is a device that stores various kinds of information for efficiently writing data requested by the host 2. The buffer 34 is provided, for example, by using an area of the SRAM (not illustrated) in the controller 11. The buffer 34 has, for example, three fields (a1 to a3). The field a1 (SCM Buf. No.) is a field that stores an entry number of the buffer 42 provided in the nonvolatile memory 12. The field a2 (Addr) is a field that stores an address indicating the position of the memory cells 43 provided in the nonvolatile memory 12. The field a3 (Data) is a field that temporarily stores data requested to be written by the host 2 or data read from the nonvolatile memory 12.

The nonvolatile memory 12 includes a control circuit 41, a buffer 42, and memory cells 43. Hereinafter, components, including the control circuit 41 and the buffer 42, but excluding the memory cells 43 in the nonvolatile memory 12, may be collectively referred to as peripheral circuits.

The control circuit 41 is a device that controls components in the nonvolatile memory 12, specifically, the buffer 42 and the memory cells 43. The control circuit 41 controls the writing process of the data to the memory cells 43 and the reading process of the data from the memory cells 43 according to the command from the controller 11. The control circuit 41 uses the buffer 42 for efficiently writing data requested by the host 2. A method of using the buffer 42 is described below.

The buffer 42 is a device that stores various types of information for efficiently writing data requested by the host 2. The buffer 42 is provided, for example, in the peripheral circuit area in the nonvolatile memory 12. For comparison with the data to be written, the data read from the memory cells 43 is stored in the buffer 42. The memory cells 43 is an overwrite-type nonvolatile memory.

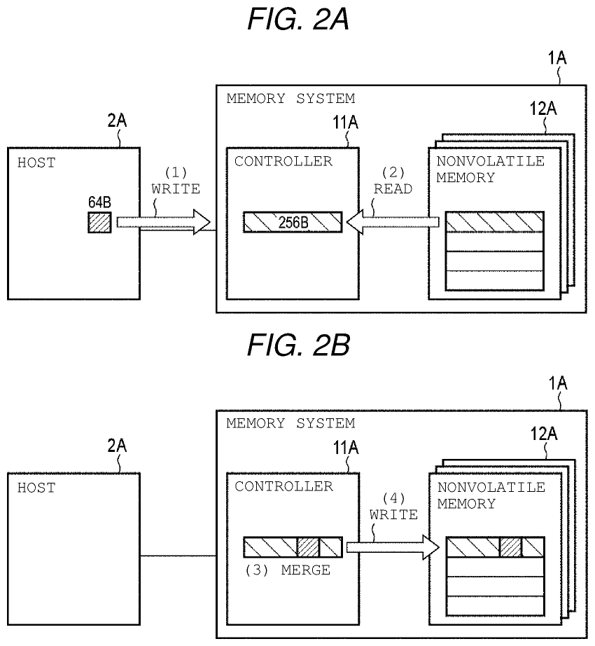

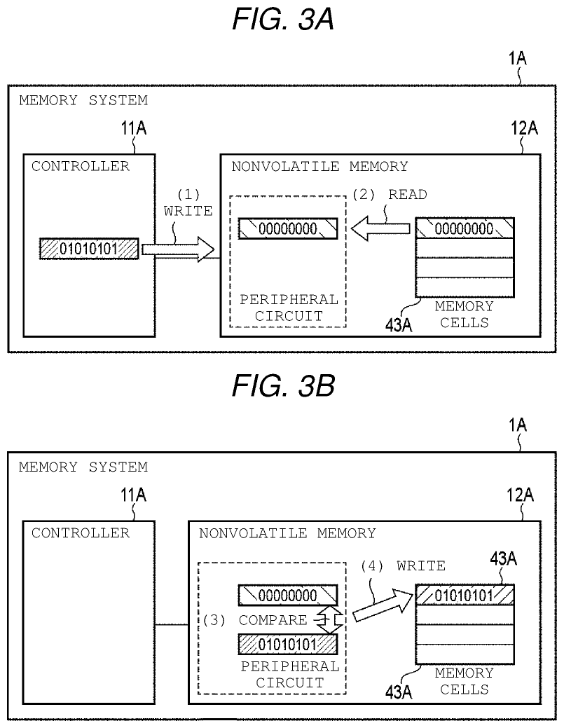

Here, a comparative example to the first embodiment is described with reference to FIGS. 2 and 3. FIGS. 2A and 2B illustrates an information processing system that includes a memory system 1A and a host 2A that is connected to the memory system 1A. The memory system 1A includes a controller 11A and a nonvolatile memory (SCM) 12A.

The host 2A writes data to the memory system 1A or reads data from the memory system 1A in units of 64 bytes. On the other hands, in the memory system 1A, the controller 11A writes data to the nonvolatile memory 12A or reads data from the nonvolatile memory 12A not in units of 64 bytes but in larger units, which is 256 bytes. That is, the unit size for access to the memory system 1A by the host 2A and the unit size for access to the nonvolatile memory 12A by the controller 11A in the memory system 1A are different from each other.

Here, as illustrated in FIG. 2A, the host 2A issues a write command for requesting the memory system 1A to write data of 64 bytes (1). In the memory system 1A that receives this write command, the controller 11A reads the data stored in the area of 256 bytes that includes an area of 64 bytes that is a storage destination of the write data from the nonvolatile memory 12A and stores the data in a buffer (2).

Subsequently, as illustrated in FIG. 2B, the controller 11A combines the write data of 64 bytes with the data of 256 bytes that is read from the nonvolatile memory 12A in the buffer (3). This process is also referred to as merging. The controller 11A writes the merged data of the 256 bytes with which the write data of 64 bytes is merged, back to the nonvolatile memory 12A (4). The writing of the data back to the nonvolatile memory 12A (4) is not required to be necessarily performed after the merging of the data (3). The writing of the data back to the nonvolatile memory 12A (4) may be performed at various timings depending on the buffer management algorithm.

On the other hands, memory cells 43A of the nonvolatile memory 12A such as the SCM generally has limited endurance, and thus there is a need to reduce the number of times (amount) of data rewriting as much as possible. Therefore, as illustrated in FIG. 2B, for example, with respect to the process (4) which is the writing of the data back to the nonvolatile memory 12A, in the nonvolatile memory 12A, a process of reducing the number of times (amount) of data rewriting to the memory cells 43A may be performed.

As illustrated in FIG. 3A, the controller 11A issues a write command for requesting the nonvolatile memory 12A to write data (1). The nonvolatile memory 12A that receives this write command reads the data stored in the area of the storage destination of the write data from the memory cells 43A and stores the data in the buffer of the peripheral circuits (2).

Subsequently, as illustrated in FIG. 3B, the nonvolatile memory 12A compares the data read from the memory cells 43A and the data received from the controller 11A (3). The nonvolatile memory 12A writes only a portion of data (bit) different from the data read from the memory cells 43A among the data received from the controller 11A to the memory cells 43A (4).

By writing only a different portion from the data already stored in the memory cells 43A, in comparison with a case of writing the entire data received from the controller 11A, overhead of one time of reading occurs, but the number of times (amount) of writing of the data to the memory cells 43A can be reduced. Although a read operation influences endurance of the memory cells according to the type of the nonvolatile memory, generally a write operation has a stronger effect on endurance. Therefore, even though one time of extra reading occurs, endurance is enhanced in the case of FIG. 3B relative to the case of FIG. 3A.

In the comparative example described with reference to FIGS. 2 and 3, the same data is read from the memory cells 43A two times. The reading of the data from the memory cells 43A two times when the write command is received from the host 2A may be considered to be overhead. The memory system 1 of the first embodiment includes a structure of capable of reducing such overhead.

As the reason why the unit size for access to the memory system 1 by the host 2 and the unit size for access to the nonvolatile memory 12 by the controller 11 in the memory system 1 are different from each other, for example, the case where the host 2 requests the memory system 1 to write or read the data in various sizes such as 8 bytes, 64 bytes, and 256 bytes is considered.

As another reason, generally, a physical design factor in which the access unit size has to be large in a large-capacity memory is considered. For example, when the host 2 has 64 bytes as the unit size for access to the memory system 1, if the setting of the unit size for access to the nonvolatile memory 12 by the controller 11 in the memory system 1 to 256 bytes or less is physically impossible, the access unit sizes of both may be different from each other.

As still another reason, if the unit size for access to the nonvolatile memory 12 by the controller 11 in the memory system 1 is set to be identical to the unit size for access to the memory system 1 by the host 2, there may be a case where reliability requested by the host 2 is not satisfied. The nonvolatile memory 12 has an Error-Correcting Code (ECC) parity in preparation for an error (e.g., bit error). When ECC is employed, even though the size ratio of the data main body and ECC parity is the same, error correction ability increases with the absolute size of the data main body.

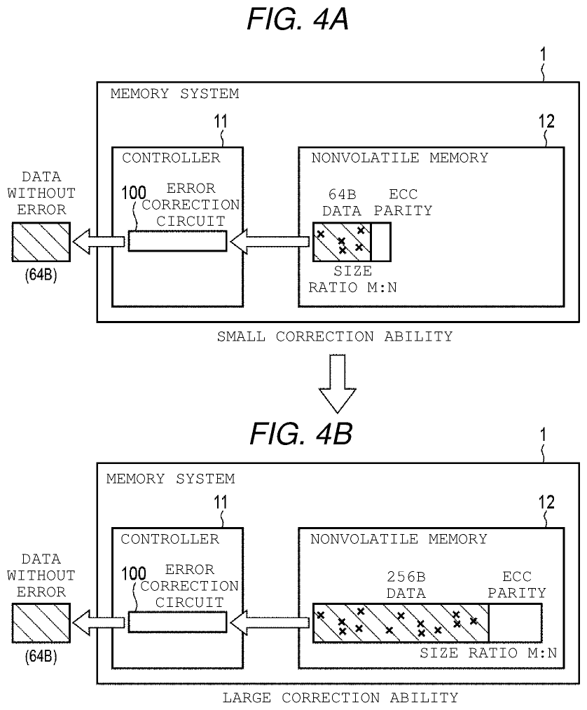

For example, as illustrated in FIGS. 4A and 4B, even though the size ratio of the data main body and ECC parity is M:N in both cases, the ability of correcting an error provided in the data of 256 bytes by an error correction circuit 100 using the ECC parity illustrated in FIG. 4B is higher than the ability of correcting an error provided in the data of 64 bytes by the error correction circuit 100 by using the ECC parity illustrated in FIG. 4A. The correction ability of the error correction circuit 100 in FIG. 4A may not be able to satisfy the reliability requested by the host 2, while the correction ability of the error correction circuit 100 in FIG. 4B may be able to satisfy the reliability requested by the host 2. In such cases, when the unit size for access to the memory system 1 by the host 2 is 64 bytes, it may not be possible to cause the access unit size of the host 2 to be identical to the access unit size of the controller 11.

When the reason why the unit size for access to the memory system 1 by the host 2 and the unit size for access to the nonvolatile memory 12 by the controller 11 in the memory system 1 are different from each other is because the reliability requested by the host 2 is not satisfied, as described with reference to FIGS. 4A and 4B, in the memory system 1, the data having the unit size for access to the nonvolatile memory 12 by the controller 11 may be located in the plurality of nonvolatile memories 12 in a distributed manner.

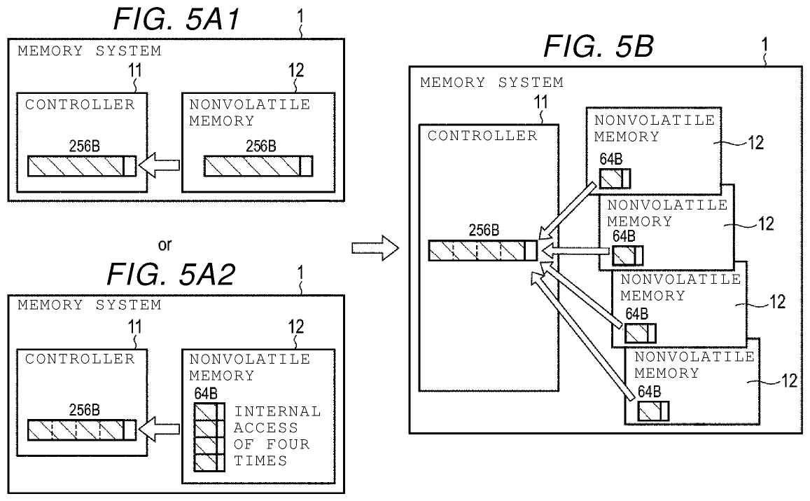

In FIGS. 5A1, 5A2, and 5B, some examples of the data stored in the nonvolatile memory 12 are illustrated.

FIGS. 5A1 and 5A2 illustrate an example in which the memory system 1 stores the data having the unit size for access to the nonvolatile memory 12 by the controller 11 in a single nonvolatile memory 12. In FIG. 5A1, data is stored in the single nonvolatile memory 12 as one set. In FIG. 5A2, data is divided into a plurality of items of data and stored in the single nonvolatile memory 12.

In FIG. 5A1, the size of each item of data stored in the nonvolatile memory 12 is large, and thus the transmission of the data, for example, from the nonvolatile memory 12 to the controller 11 takes time. In FIG. 5A2, the sizes of respective items of data in the nonvolatile memory 12 are small, but a plurality of times of accesses are performed sequentially, and thus it also takes time. That is, when one item of data is stored in the single nonvolatile memory 12, the write latency of the memory system 1 may be deteriorated.

On the other hands, FIG. 5B illustrates an example in which the memory system 1 stores the data having the unit size for access to the nonvolatile memory 12 by the controller 11 in a distributed manner across a plurality of nonvolatile memories 12.

In case of FIG. 5B, a plurality of accesses of data in a small size are performed in parallel, and the ideal required time thereof is only “1/the number of divisions”. Therefore, it is preferable that the memory system 1 locates the data having the unit size for access to the nonvolatile memory 12 by the controller 11 in a distributed manner across a plurality of nonvolatile memories 12. That is, it is preferable that the memory system 1 includes a plurality of nonvolatile memories 12. The following embodiments are described using the premise of FIG. 5A1 for the sake of simplification of the description.

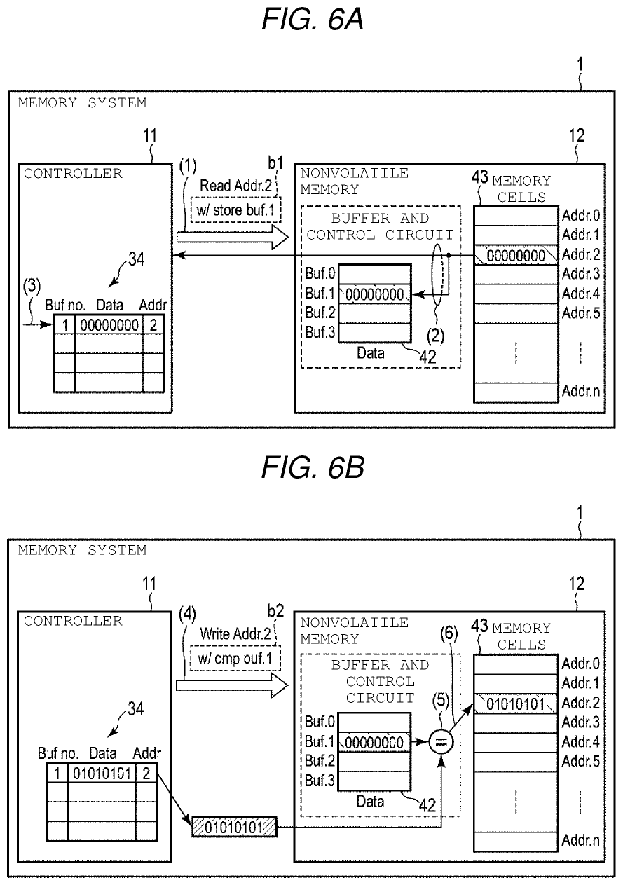

Subsequently, with reference to FIGS. 6A and 6B, an operation of storing the data that is requested to be written from the host 2 in the memory cells 43, by the memory system 1 according to the first embodiment is described. Similar to the comparative example, in the first embodiment, the host 2 writes data to the memory system 1 or reads data from the memory system 1 in units of 64 bytes. On the other hands, in the memory system 1, data is written to the nonvolatile memory 12 or data is read from the nonvolatile memory 12 not in units of 64 bytes but in a larger unit, which is 256 bytes by the controller 11. That is, the unit size for access to the memory system 1 by the host 2 and the unit size for access to the nonvolatile memory 12 by the controller 11 in the memory system 1 are different from each other.

FIG. 6A illustrates a reading process of data from the memory cells 43 that corresponds to the reading process of the data from the memory cells 43A that is performed by the memory system 1A according to the comparative example in order to merge the write data described with reference to FIG. 2A and that is performed by the memory system 1 according to the first embodiment in order to merge the write data.

The controller 11 issues the read command for requesting the nonvolatile memory 12 to read data of the area of 256 bytes including the area of 64 bytes that is the storage destination of the write data, from the memory cells 43 (1). In the read command, the controller 11 designates an address (Addr. 2) indicating the position of the corresponding area of 256 bytes, and adds option information (b1) including the designation of an entry (buf. 1) in the buffer 42 of the nonvolatile memory 12 as an instruction to store the data read from the memory cells 43 in the corresponding entry of the buffer 42.

When the read command to which the option information (b1) has been added, is received, the nonvolatile memory 12 transmits the data read from the memory cells 43 to the controller 11 and stores the data in the designated entry of the buffer 42 (2). When the read command to which the option information (b1) is not added is received, the nonvolatile memory 12 does not store the data read from the memory cells 43 in the buffer 42. That is, the data read from the memory cell 43 is transmitted only to the controller 11. For example, when the host 2 issues a read command, the controller 11 does not add the option information (b1) to a read command it issues to the nonvolatile memory 12.

The controller 11 stores the address designated by the read command and the entry designated by the option information (b1) added to the corresponding read command in the buffer 34 together with the data received from the nonvolatile memory 12 (3).

FIG. 6B illustrates the writing process of the data of 256 bytes obtained by merging the data of 256 bytes that is read in FIG. 6A to the write data of 64 bytes of the host 2, to the memory cells 43. At this point, the data of the buffer 34 is updated to be in the merged state.

The controller 11 issues the write command for requesting the nonvolatile memory 12 to write the merged data stored in the buffer 34 to the memory cells 43 (4). In the write command, the controller 11 designates the address stored in the buffer 34, and adds option information (b2) that includes the designation of the entry (buf. 1) of the buffer 42 of the nonvolatile memory 12 that is stored in the buffer 34, as an instruction to compare the data that is stored in the buffer 42 with the write data.

When the write command to which the option information (b2) has been added, is received, the nonvolatile memory 12 compares the data stored in the designated entry of the buffer 42 with the data received from the controller 11 (5). The nonvolatile memory 12 writes only a portion of data (bit) that is different from the data stored in the buffer 42 among the data received from the controller 11, to the memory cells 43 (6). When the write command to which no option information (b2) is added, is received, the nonvolatile memory 12 does not compare the write command with the data stored in the buffer 42 but compares the write command with the data stored in the memory cells 43 as in the comparative example. Examples of the case where the controller 11 issues a write command to which no option information (b2) is added include a case where the size of the data that is requested to be written to the memory system 1 by the host 2 and the size of the data that is requested to be written to the nonvolatile memory 12 by the controller 11 in the memory system 1 are identical to each other. In this case, the controller 11 issues a write command without adding the option information (b2) and without reading the data for the purpose of merging the write data.

In the memory system 1A according to the comparative example, as illustrated in FIG. 3A, in order to reduce the number of times (amount) of writing of the data to the memory cells 43A, specifically, in order to compare the data that is requested to be written to the memory cells 43A with the data stored in the memory cells 43, the reading process of the data from the memory cells 43A is performed for the second time. In contrast, in the memory system 1 according to the first embodiment, the controller 11 and the nonvolatile memory 12 cooperate with each other to store the data read from the memory cells 43 in case of the reading of the data for the first time for the purpose of merging the write data, in the buffer 42. Accordingly, the reading of the data for the second time for the purpose of the reduction of the number of times (amount) of the writing of the data to the memory cells 43 is not performed. That is, the memory system 1 according to the first embodiment can reduce the overhead in case of writing the data that occurs due to the difference of the access unit sizes.

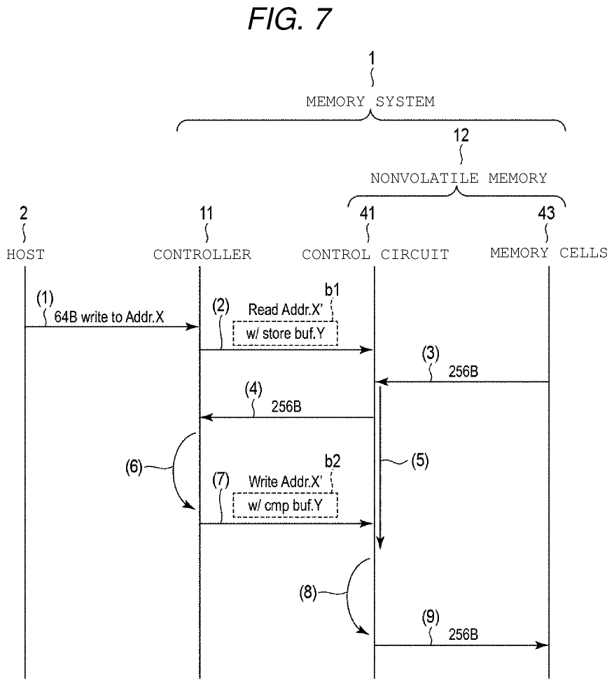

FIG. 7 is a sequence diagram illustrating a flow of an operation in case of writing data by the information processing system including the memory system 1 according to the first embodiment.

The host 2 issues the write command to the memory system 1 (1). An address (Addr. X) indicating the position of a memory space provided by the memory system 1 is designated to the write command issued by the host 2.

The memory system 1 that receives the write command from the host 2 issues the read command for designating an address (Addr. X′) indicating the position of the memory cells 43 corresponding to the address (Addr. X) designated from the host 2 to the nonvolatile memory 12 by the controller 11 (2). The controller 11 has an address converting function that converts the address used by the host 2 to an address used in the memory system 1. Here, strictly, “Addr. X′” corresponding to “Addr. X” is not an address that can be obtained from “Addr. X” by the address converting function, but an address including the converted address and indicating the head of the area of 256 bytes for one section on the memory cells 43. When the converted address is an address indicating the head of the area of 256 bytes, “Addr. X′” is the address obtained from “Addr. X”.

With respect to the read command that is issued to the nonvolatile memory 12 according to the write command from the host 2, the controller 11 adds the option information (b1) for instructing the buffer 42 to store the data read from the memory cells 43. Entry information that designates the entry (buf. Y) of the buffer 42 is provided in the option information (b1). When the read command to which the option information (b1) has been added, is issued to the nonvolatile memory 12, the controller 11 stores the entry information provided in the option information (b1) and the address information designated by the read command in the buffer 34 together with the data transmitted from the nonvolatile memory 12.

In the nonvolatile memory 12 that receives the read command from the controller 11, the control circuit 41 reads the data from the memory cells 43 (3). The control circuit 41 transmits the data read from the memory cells 43 to the controller 11 (4). When the option information (b1) is added to the read command, the control circuit 41 stores the data read from the memory cells 43 in the entry designated by the corresponding option information (b1) of the buffer 42 (5).

The controller 11 merges the data read from the nonvolatile memory 12 with the write data received from the host 2 (6). The controller 11 issues the write command for requesting the memory cells 43 to write the merged data to the nonvolatile memory 12 (7). The controller 11 adds the option information (b2) for instructing the comparison between the data stored in the buffer 42 and the write data to the corresponding write command. The entry information that is provided in the option information (b1) added to the read command of (2) and designates an entry (buf. Y) of the buffer 42 in which the read data is stored is provided in the option information (b2).

The nonvolatile memory 12 that receives the write command to which the option information (b2) has been added, from the controller 11 compares the data received from the controller 11 by the control circuit 41 with the data stored in the buffer 42 (8). The control circuit 41 writes only a portion of the data (bit) that is different from the data stored in the buffer 42 among the data received from the controller 11 to the memory cells 43 (9).

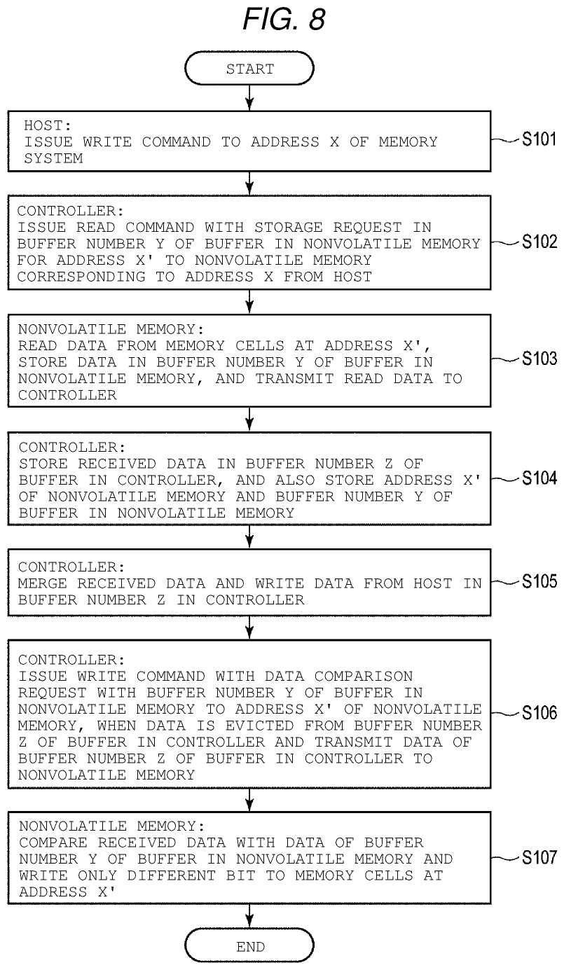

FIG. 8 is a flowchart illustrating an operation procedure in case of writing data by the information processing system including the memory system 1 according to the first embodiment.

The host 2 issues the write command to an address X of the memory system 1 (S101).

The controller 11 issues a read command with a storage request (option information) to a buffer number (entry) Y of the buffer 42 in the nonvolatile memory 12, to the address X′ of the nonvolatile memory 12 corresponding to the address X from the host 2 (S102).

The nonvolatile memory 12 reads the data from the memory cells 43 of the address X′, stores the data at the buffer number Y of the buffer 42 in the nonvolatile memory 12 and transmits the read data to the controller 11 (S103).

The controller 11 stores the received data to a buffer number Z of the buffer 34 in the controller 11 and stores the address X′ of the nonvolatile memory 12 and the buffer number Y of the buffer 42 in the nonvolatile memory 12 (S104). The controller 11 merges the received data and the write data from the host 2 in the buffer number Z of the buffer 34 in the controller 11 (S105).

When the data is evicted from the buffer number Z of the buffer 34 in the controller 11, the controller 11 issues a write command with a data comparison request (option information) with the buffer number Y of the buffer 42 in the nonvolatile memory 12, to the address X′ of the nonvolatile memory 12 and transmits the data of the buffer number Z of the buffer 34 in the controller 11 to the nonvolatile memory 12 (S106). The timing when the data is evicted from the buffer may be set in various ways by the management algorithm of the buffer.

The nonvolatile memory 12 compares the received data with the data of the buffer number Y of the buffer 42 in the nonvolatile memory 12, and writes only the different bit to the memory cells 43 of the address X′ (S107).

As described above, in the memory system 1 according to the first embodiment, the controller 11 and the nonvolatile memory 12 cooperate with each other and use the option information, to store the data read from the memory cells 43 in case of the reading of the data for the first time in the buffer 42 so that the reading of the data for the second time for the purpose of the reduction of the number of times (amount) of the writing of the data to the memory cells 43 may not be performed. The reduction of the number of times of reading enhances endurance, though not as much as the reduction of the number of times of writing. That is, the memory system 1 according to the first embodiment can reduce the overhead in case of writing the data that occurs due to the difference of the access unit sizes.

### Second Embodiment

Subsequently, a second embodiment is described. It is assumed that a memory system according to the second embodiment is also implemented as an SCM module. Also, it is assumed that a memory system according to the second embodiment is also connected to the host that is an information processing device such as a server or a personal computer. That is, it is assumed that a host and a memory system are connected to each other to make up the information processing system. The configurations which are the same as those in the first embodiment are denoted by the same reference numerals, and the descriptions thereof are omitted.

In the memory system 1 according to the second embodiment, when the write command is received from the host 2, first, the reading process of the data from the memory cells 43 for the purpose of merging the write data is performed by a normal read command to which option information is not added.

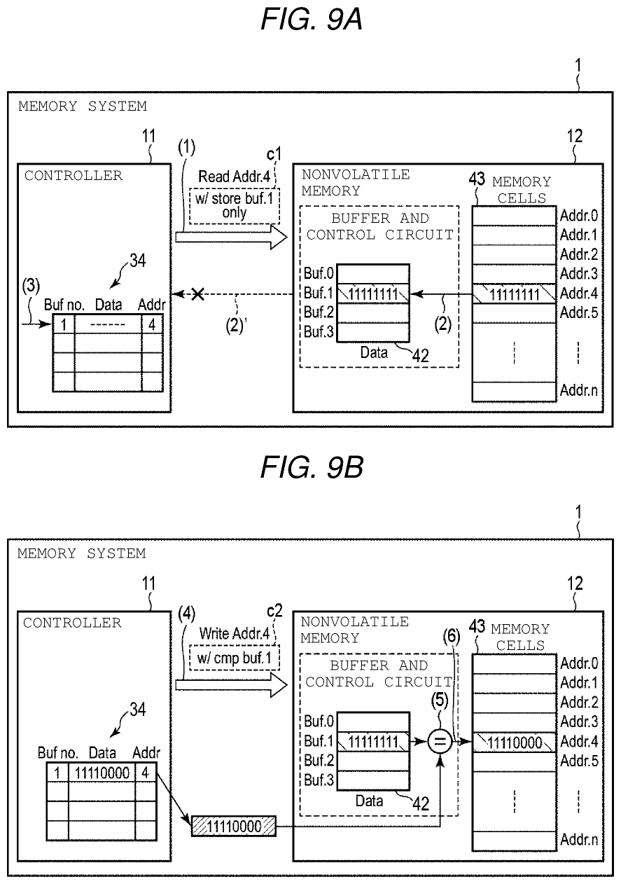

FIGS. 9A and 9B are diagrams illustrating a configuration example of the memory system according to the second embodiment. In FIGS. 9A and 9B, an operation after the write data has been merged by the controller 11, when the memory system 1 according to the second embodiment receives the write command from the host 2, is illustrated.

FIG. 9A illustrates the reading process of the data from the memory cells 43 for the second time, which is performed by the memory system 1 according to the second embodiment as a preparation work when the merged data is written to the memory cells 43.

The controller 11 issues a read command for requesting to read the data of the area of 256 bytes that is the storage destination of the merged data from the memory cells 43, to the nonvolatile memory 12 (1). In the read command, the controller 11 designates an address (Addr. 4) indicating the area of the corresponding area of 256 bytes, and adds option information (c1) as an instruction to only read the data read from the memory cells 43 for storage in the buffer 42. Entry information indicating the entry of the buffer 42 of the nonvolatile memory 12 is provided in the option information (c1).

The controller 11 issues the read command to which the corresponding option information (c1) is added, for example, at a timing when the merged data is expected to be evicted from the buffer 34. This timing may be determined based on the amount of data stored in the buffer thereafter, the elapsed time after the data was stored in the buffer, and the like.

When the read command to which the option information (c1) has been added, is received, the nonvolatile memory 12 stores the data read from the memory cells 43 to the designated entry of the buffer 42 (2). At this point, the nonvolatile memory 12 does not transmit the data read from the memory cells 43 to the controller 11 (2)′. The operation of the nonvolatile memory 12 when a read command to which the option information (c1) is not added is received, is the same as described in the first embodiment.

The controller 11 stores the address designated by the read command and the entry designated by the option information (c1) added to the read command, in the buffer 34 (3). The data read in the reading process for the first time to which the write data has been merged, is stored in the buffer 34.

FIG. 9B illustrates a writing process of the data of 256 bytes that has been read from the memory cells 43 in the data reading process for the first time and to which the write data of 64 bytes of the host 2 has been merged, to the memory cells 43.

The controller 11 issues a write command to write the merged data that is stored in the buffer 34 to the memory cells 43, to the nonvolatile memory 12 (4). In the write command, the controller 11 designates the address stored in the buffer 34, and adds option information (c2) that includes the designation of the entry of the buffer 42 of the nonvolatile memory 12 that is stored in the buffer 34, as an instruction to compare the data stored in the buffer 42 with the write data.

When the write command to which the option information (c2) is added is received, the nonvolatile memory 12 compares the data stored in the designated entry of the buffer 42 with the data received from the controller 11 (5). The nonvolatile memory 12 writes only a portion of data (bit) that is different from the data stored in the buffer 42 among the data received from the controller 11 to the memory cells 43 (6). The operation of the nonvolatile memory 12 when the write command to which the option information (c2) is not added is received is the same as described in the first embodiment.

In the memory system 1 according to the second embodiment, in the same manner as the memory system 1A of the comparative example, the reading of data of the second time is performed, but the write latency can be reduced by prefetching the data to be compared into the buffer 42 of the nonvolatile memory 12 in advance, prior to writing the merged data.

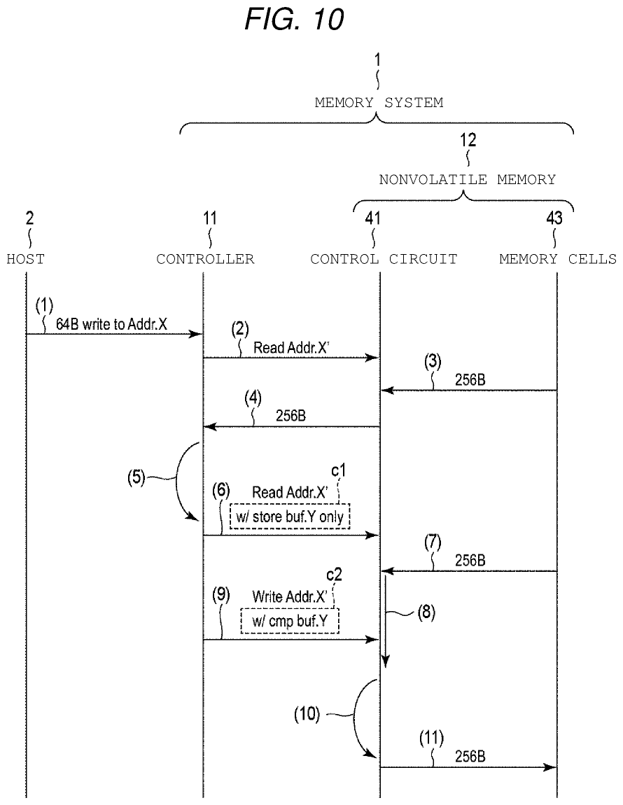

FIG. 10 is a sequence diagram illustrating the flow of the operation in case of writing the data of the information processing system including the memory system 1 according to the second embodiment.

The host 2 issues the write command to the memory system 1 (1). The address (Addr. X) indicating the position on the memory space provided by the memory system 1 is designated in the write command issued by the host 2.

In the memory system 1 that receives the write command from the host 2, the controller 11 issues the read command that designates the address (Addr. X′) indicating the position of the memory cells 43 corresponding to the address (Addr. X) designated from the host 2, to the nonvolatile memory 12 (2).

In the nonvolatile memory 12 that receives the read command from the controller 11, the control circuit 41 reads the data from the memory cells 43 (3). The control circuit 41 transmits the data read from the memory cells 43 to the controller 11 (4).

The controller 11 merges the data read from the nonvolatile memory 12 and the write data received from the host 2 (5).

The controller 11 issues the read command that designates the address (Addr. X′) indicating the position of the memory cells 43 corresponding to the address (Addr. X) designated from the host 2 in preparation for writing the merged data to the memory cells 43, again (6). With respect to the read command, the controller 11 adds the option information (c1) for instructing the buffer 42 to store (prefetch) the data read from the memory cells 43. The entry information for designating the entry of the buffer 42 is provided in the option information (c1). When the read command to which the option information (c1) has been added, is issued to the nonvolatile memory 12, the controller 11 stores the entry information provided in the option information (c1) and the address information designated by the read command in the buffer 34.

In the nonvolatile memory 12 that receives the read command from the controller 11, the control circuit 41 reads the data from the memory cells 43 (7). In case of the read command to which the option information (c1) has been added, the control circuit 41 does not transmit the data read from the memory cells 43 to the controller 11. The control circuit 41 stores the data read from the memory cells 43 in the entry of the buffer 42 designated by the corresponding option information (c1) (8).

The controller 11 issues the write command to write the merged data to the memory cells 43, to the nonvolatile memory 12 (9). The controller 11 adds the option information (c2) for instructing the comparison between the data stored in the buffer 42 with the write data. The entry information for designating the entry of the buffer 42, which was provided in the option information (c1) added to the read command of (6) and in which the read data is stored, is provided in the option information (c2).

When the nonvolatile memory 12 receives from the controller 11 the write command to which the option information (c2) has been added, the control circuit 41 compares the data received from the controller 11 and the data stored in the buffer 42 (10). The control circuit 41 writes only a portion of the data (bit) different from the data stored in the buffer 42 to the memory cells 43 among the data received from the controller 11 (11).

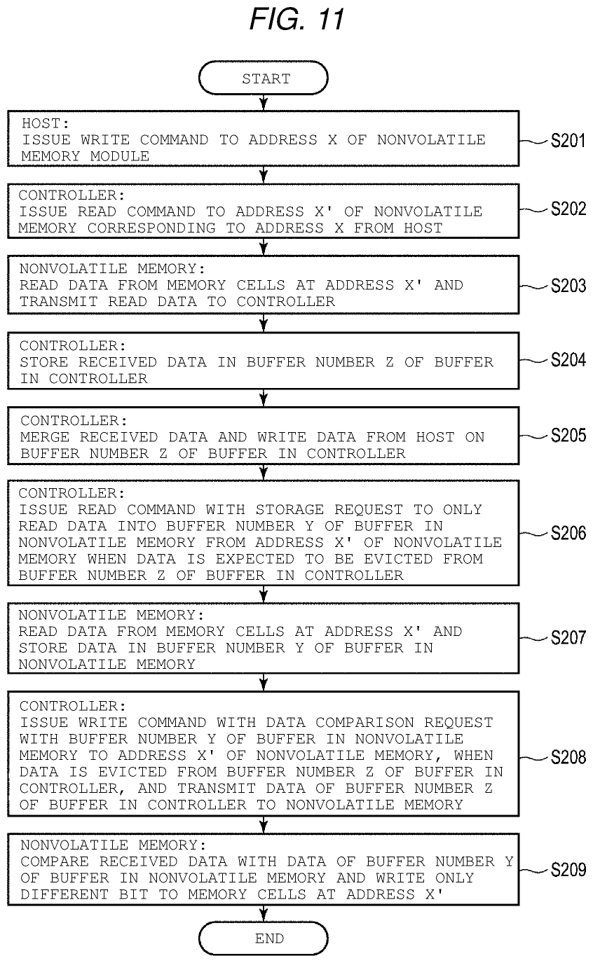

FIG. 11 is a flowchart illustrating an operation procedure in case of writing data of the information processing system including the memory system 1 according to the second embodiment.

The host 2 issues the write command to the address X of the memory system 1 (S201). The controller 11 issues the read command to the address X′ of the nonvolatile memory 12 corresponding to the address X from the host 2 (S202). The nonvolatile memory 12 reads the data from the memory cells 43 of the address X′ and transmits the read data to the controller 11 (S203).

The controller 11 stores the received data in the buffer number Z of the buffer 34 in the controller 11 (S204). The controller 11 merges the received data and the write data from the host 2 in the buffer number Z of the buffer 34 in the controller 11 (S205).

When the data from the buffer number Z of the buffer 34 in the controller 11 is expected to be evicted, the controller 11 issues the read command with the storage request (option information) to only read data into the buffer number Y of the buffer 42 in the nonvolatile memory 12, from the address X′ of the nonvolatile memory 12 (S206).

The nonvolatile memory 12 reads the data from the memory cells 43 of the address X′ and stores the data in the entry Y of the buffer 42 in the nonvolatile memory 12 (S207).

When the data from the buffer number Z of the buffer 34 in the controller 11 is evicted, the controller 11 issues the write command with the data comparison request (option information) with the buffer number Y in the nonvolatile memory 12, to the address X′ of the nonvolatile memory 12 and transmits the data of the buffer number Z of the buffer 34 in the controller 11 to the nonvolatile memory 12 (S208).

The nonvolatile memory 12 compares the receive data with the data of the buffer number Y in the nonvolatile memory 12 and writes only the different bit to the memory cells 43 of the address X′ (S209).

As described above, in the memory system 1 according to the second embodiment, the controller 11 and the nonvolatile memory 12 cooperate with each other and use the option information, so that the write latency can be reduced by prefetching the data to be compared into the buffer 42 of the nonvolatile memory 12 in advance, prior to writing the merged data.

### Third Embodiment

Subsequently, a third embodiment is described. It is assumed that a memory system according to the third embodiment is also implemented as an SCM module. Also, it is assumed that the memory system according to the third embodiment is connected to the host that is an information processing device such as a server or a personal computer. That is, it is assumed that a host and a memory system are connected to each other to make up the information processing system. The configurations which are the same as those in the first and second embodiments are denoted by the same reference numerals, and the descriptions thereof are omitted.

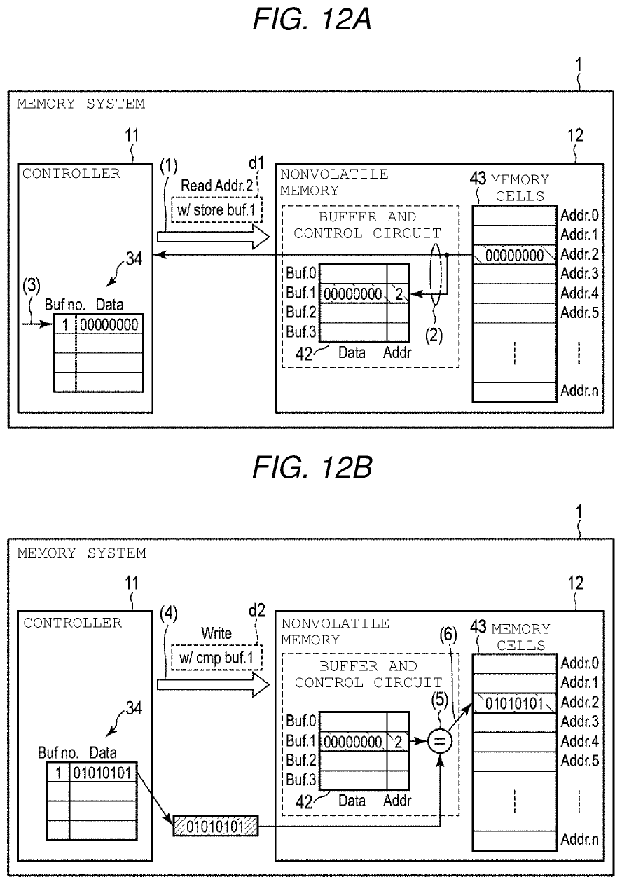

In the memory system 1 according to the third embodiment, the buffer 42 of the nonvolatile memory 12 further stores the address of the memory cells 43. FIGS. 12A and 12B are diagrams illustrating one configuration example of a memory system according to the third embodiment.

FIG. 12A illustrates a data reading process from the memory cells 43 that is performed by the memory system 1 according to the third embodiment to merge the write data.

The controller 11 issues a read command requesting to read the data of the area of 256 bytes including the area of 64 bytes that is the storage destination of the write data from the memory cells 43, to the nonvolatile memory 12 (1). At this point, the controller 11 designates the address (Addr. 2) indicating the position of the corresponding area of 256 bytes. At this point, the controller 11 adds option information (d1) that includes the designation of the entry (buf. 1) of the buffer 42 of the nonvolatile memory 12 and instructs the data read from the memory cells 43 to be stored in the corresponding entry of the buffer 42, to the read command issued to the nonvolatile memory 12. That is, the option information (d1) is the same as the option information (b1) according to the first embodiment in terms of format.

When the read command to which the option information (d1) is added is received, the nonvolatile memory 12 transmits the data read from the memory cells 43 to the controller 11 and stores the data in the designated entry of the buffer 42 (2). At this point, in the nonvolatile memory 12 according to the third embodiment, the address designated by the read command is also stored in the designate entry of the buffer 42. The operation of the nonvolatile memory 12 when the read command to which the option information (d1) is not added is received is the same as described in the first embodiment.

In the controller 11 according to the third embodiment, only the entry designated by the option information (d1) added to the read command is stored in the buffer 34 together with the data received from the nonvolatile memory 12 (3). That is, the address designated by the read command is not stored in the buffer.

FIG. 12B illustrates a writing process of data of 256 bytes obtained by merging data of 256 bytes read in FIG. 12A and write data of 64 bytes of the host 2 to the memory cells 43. At this point, the data of the buffer 34 is updated to be in the merged state.

The controller 11 issues the write command to request the nonvolatile memory 12 to write the merged data stored in the buffer 34 to the memory cells 43 (4). At this point, the controller 11 adds option information (d2) that includes the designation of the entry (buf. 1) of the buffer 42 of the nonvolatile memory 12, and instructs the comparison between the data stored in the buffer 42 and the write data, to a write command issued to the nonvolatile memory 12. That is, the option information (d2) is the same as the option information (b2) according to the first embodiment in terms of format.

As described above, in case of issuing the read command to which the option information (d1) is added, the address of the memory cells 43 is stored in the buffer 42 of the nonvolatile memory 12. As a result, when issuing the write command to which the option information (d2) is added, the controller 11 can omit the designation of the address in the option information (d2). In other words, the controller 11 needs to only designate the entry of the buffer 42 in the option information (d2).

For example, when the nonvolatile memory 12 is a large-capacity memory equipped with many memory cells 43, the addresses indicating the positions of the memory cells 43 may reach several tens of bits. In this case, if the designation of the addresses can be omitted only by designating the entry of the buffer, the command length of the write command can be shortened. If the command length can be shortened, the reduction of the write latency or the utilization efficiency of signal lines between the controller and the nonvolatile memories can be enhanced.

When the write command to which the option information (d2) is added is received, the nonvolatile memory 12 compares the data stored in the designated entry of the buffer 42 and the data received from the controller 11 (5). The nonvolatile memory 12 writes only a portion of data (bit) different from the data stored in the buffer 42 among the data received from the controller 11 to the memory cells 43A, based on the address stored in the buffer 42 (6).

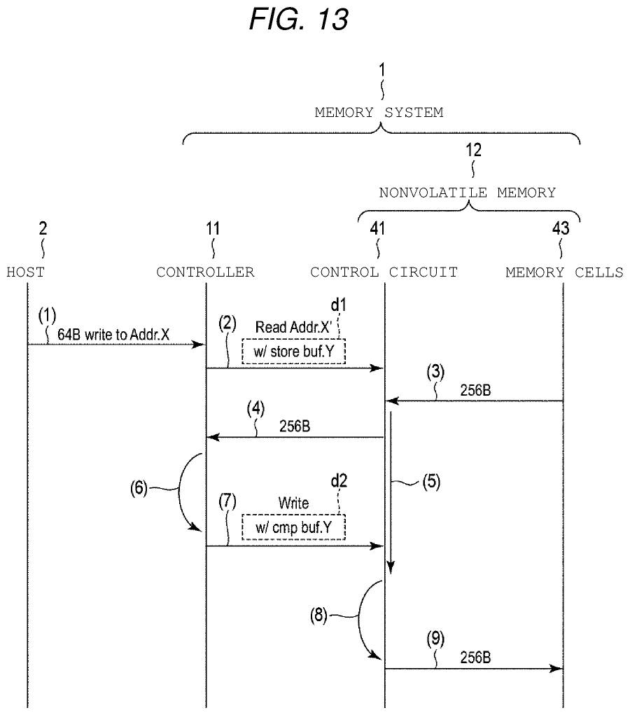

FIG. 13 is a sequence diagram illustrating the flow of the operation in case of writing data of the information processing system including the memory system 1 according to the third embodiment.

The host 2 issues the write command to the memory system 1 (1). The address (Addr. X) indicating the position on the memory space in which the memory system 1 is provided is designated in the write command issued by the host 2.

In the memory system 1 that receives the write command from the host 2, the controller 11 issues the read command that designates the address (Addr. X′) indicating the position of the memory cells 43 corresponding to the address (Addr. X) designated from the host 2, to the nonvolatile memory 12 (2).

With respect to the read command that is issued to the nonvolatile memory 12 in response to the write command from the host 2, the controller 11 adds the option information (d1) for instructing the data read from the memory cells 43 to be stored in the buffer 42. The entry information for designating the entry (buf. Y) of the buffer 42 is provided in the option information (b1). When the read command to which the option information (d1) is added is issued to the nonvolatile memory 12, the controller 11 stores the entry information provided in the option information (d1) in the buffer 34 together with the data transmitted from the nonvolatile memory 12.

In the nonvolatile memory 12 that receives the read command from the controller 11, the control circuit 41 reads the data from the memory cells 43 (3). The control circuit 41 transmits the data read from the memory cells 43 to the controller 11 (4). When the option information (d1) is added to the read command, the control circuit 41 stores the data read from the memory cells 43 in the entry of the buffer 42 designated by the corresponding option information (b1) (5). At this point, the control circuit 41 also stores the address designated by the read command in the buffer 42.

The controller 11 merges the data read from the nonvolatile memory 12 and the write data received from the host 2 (6). The controller 11 issues the write command to write the merged data to the memory cells 43, to the nonvolatile memory 12 (7). The controller 11 adds to the write command the option information (d2) for instructing the comparison between the data stored in the buffer 42 and the write data. The entry information that is provided in the option information (d1) added to the read command of (2) and designates entry (buf. Y) of the buffer 42 in which the read data is stored is provided in the option information (d2). In addition, in the write command to which the option information (d2) is added is issued, the controller 11 does not need to include the designation of the address that is designated in the read command of (2).

In the nonvolatile memory 12 that receives the write command to which the option information (d2) is added, from the controller 11, the control circuit 41 compares the data received from the controller 11 and the data stored in the buffer 42 (8). The control circuit 41 writes only a portion of data (bit) different from the data stored in the buffer 42 among the data received from the controller 11 to the memory cells 43 based on the address stored in the buffer 42 (9).

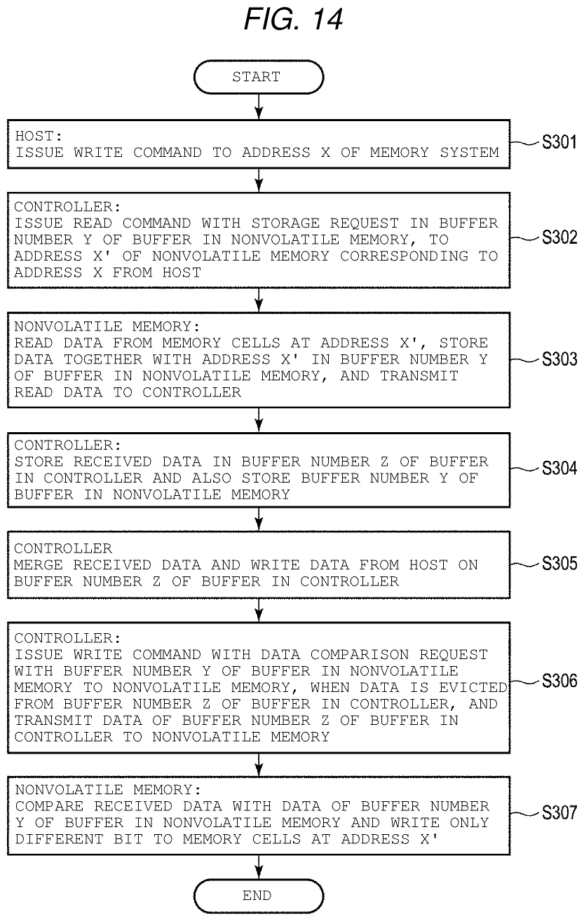

FIG. 14 is a flowchart illustrating an operation procedure in case of reading data by the information processing system including the memory system 1 according to the third embodiment.

The host 2 issues a write command to the address X of the memory system 1 (S301).

The controller 11 issues a read command with a storage request (option information) to the buffer number Y of the buffer 42 in the nonvolatile memory 12, to the address X′ of the nonvolatile memory 12 corresponding to the address X from the host 2 (S302).

The nonvolatile memory 12 reads the data from the memory cells 43 of the address X′, stores the data in the entry Y of the buffer 42 in the nonvolatile memory 12 together with the address X′, and transmits the read data to the controller 11 (S303).

The controller 11 stores the received data in the buffer number Z of the buffer 34 in the controller 11 and stores the buffer number Y of the buffer 42 in the nonvolatile memory 12 (S304). The controller 11 merges the received data and the write data from the host 2 in the buffer number Z of the buffer 34 in the controller 11 (S305).

When the data is evicted from the buffer number Z of the buffer 34 in the controller 11, the controller 11 issues the write command with a data comparison request (option information) with the buffer number Y of the buffer 42 in the nonvolatile memory 12, to the nonvolatile memory 12, and transmits the data of the buffer number Z of the buffer 34 in the controller 11 to the nonvolatile memory 12 (S306). In case of issuing the write command, the controller 11 does not include the designation of the address X′ of the nonvolatile memory 12.

The nonvolatile memory 12 compares the received data with the data of the buffer number Y of the buffer 34 in the nonvolatile memory 12 and writes only the different bit in the memory cells 43 of the address X′ stored in the buffer 42 (S307).

As described above, in the memory system 1 of the third embodiment, the controller 11 and the nonvolatile memory 12 cooperate with each other and use the option information, so that the designation of the address in the write command for requesting to write the merged data can be omitted. By the omission of the designation of the address, the command length is shortened, and the write latency is further reduced compared with the memory system 1 according to the first embodiment.

The method of omitting the designation of the address in the write command for requesting to write the merged data can be also applied to the memory system 1 according to the second embodiment.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A nonvolatile memory comprising:
a memory element;
a buffer; and
a control circuit that controls writing of data into the memory element or reading of data from the memory element,
wherein the control circuit is configured to
read data requested in a first command from the memory element when the first command is received, and store the data in the buffer, and
in response to a second command that includes write data, compare the write data with the data stored in the buffer, and write only a portion of the write data that is different from the data stored in the buffer into the memory element.

2. The nonvolatile memory according to claim 1, wherein
the first command is a read command to which a first option has been added, and the data that is read from the memory element in response to the first command is stored in an entry of the buffer designated in the first option and returned in response to the first command, and
the control circuit, in response to a read command that does not include the first option, reads data requested in the read command from the memory element and returns the read data without storing the read data in the buffer.

3. The nonvolatile memory according to claim 1, wherein
in response to a third command, the control circuit reads data requested in the third command from the memory element and returns the read data without storing the read data in the buffer, and
in response to the first command, the control circuit does not return the data that is read from the memory element.

4. The nonvolatile memory according to claim 1, wherein the first command designates an entry of the buffer in which the data requested in the first command is to be stored, and the second command designates an entry of the buffer in which the data to be compared with the write data is stored.

5. The nonvolatile memory according to claim 1, wherein the second command includes address information indicating a location in the memory element into which the write data is to be written.

6. The nonvolatile memory according to claim 1, wherein the control circuit is further configured to:
store in the buffer, address information indicating a location in the memory element from which the data requested in the first command is read, and
in response to the second command, write the portion of the write data that is different from the data stored in the buffer based on the address information stored in the buffer.

7. The nonvolatile memory according to claim 6, wherein the second command does not include address information indicating a location in the memory element into which the write data is to be written.

8. The nonvolatile memory according to claim 1, wherein the memory element is an overwrite-type nonvolatile memory.

9. The nonvolatile memory according to claim 1, wherein the memory element is one of a phase-change memory (PCM), a magnetoresistive memory (MRAM), a resistance change memory (ReRAM), and a ferroelectric memory (FeRAM).

10. A memory system comprising:
a nonvolatile memory including a memory element, a buffer, and a control circuit that controls writing of data into the memory element or reading of data from the memory element; and
a controller configured to control the nonvolatile memory, wherein
the control circuit is configured to
read data requested in a first command from the memory element when the first command is received, and store the data in the buffer, and
in response to a second command that includes write data, compare the write data with the data stored in the buffer, and write only a portion of the write data that is different from the data stored in the buffer into the memory element, and
the controller configured to issue first and second commands to the nonvolatile memory in response to a write command received from a host.

11. The memory system according to claim 10, wherein
the first command is a read command to which a first option has been added, and the data that is read from the memory element in response to the first command is stored in an entry of the buffer designated in the first option and returned to the controller in response to the first command, and
the second command is a write command to which a second option has been added, and the data that is compared with the write data is retrieved from an entry of the buffer designated in the second option.

12. The memory system according to claim 10, wherein
the controller is further configured to issue a read command prior to issuing the first and second commands to the nonvolatile memory in response to the write command received from the host.

13. The memory system according to claim 12, wherein
the first command is a read command to which a first option has been added, and the data that is read from the memory element in response to the first command is stored in an entry of the buffer designated in the first option and is not returned to the controller in response to the first command, and
the second command is a write command to which a second option has been added, and the data that is compared with the write data is retrieved from an entry of the buffer designated in the second option.

14. The memory system according to claim 10, wherein
the first command is a read command to which a first option has been added, and the data that is read from the memory element in response to the first command is stored in an entry of the buffer designated in the first option and returned to the controller in response to the first command, and
the second command designates an entry of the buffer in which the data to be compared with the write data is stored, and does not include address information indicating a location in the memory element into which the write data is to be written.

15. The memory system according to claim 14, wherein the control circuit is further configured to:
store in the buffer, address information indicating a location in the memory element from which the data requested in the first command is read, and
in response to the second command, write the portion of the write data that is different from the data stored in the buffer based on the address information stored in the buffer.

16. A method of controlling a nonvolatile memory that includes a memory element and a buffer, said method comprising:
in response to a first command, reading data requested in the first command from a location in the memory element designated by an address specified in the first command, and storing the data in the buffer; and
in response to a second command that includes write data, comparing the write data with the data stored in the buffer, and writing only a portion of the write data that is different from the data stored in the buffer into the memory element.

17. The method according to claim 16, wherein
the first command is a read command to which a first option has been added, and the data that is read from the memory element in response to the first command is stored in an entry of the buffer designated in the first option, and
the second command is a write command to which a second option has been added, and the data that is compared with the write data is retrieved from an entry of the buffer designated in the second option.

18. The method according to claim 17, wherein the data that is read from the memory element is returned in response to the first command.

19. The method according to claim 17, wherein the data that is read from the memory element is not returned in response to the first command.

20. The method according to claim 16, wherein
the first command is a read command to which a first option has been added, and the data that is read from the memory element in response to the first command and address information indicating a location in the memory element from which the data requested in the first command is read, are stored in an entry of the buffer designated in the first option, and
the second command designates an entry of the buffer in which the data to be compared with the write data is stored, and does not include address information indicating a location in the memory element into which the write data is to be written.
